(19) United States
(12) Patent Application Publication
(10) Pub. No.: US 2016/0152182 A1
(43) Pub. Date: Jun. 2, 2016

(54) DRIVING SUPPORT DEVICE AND DRIVING SUPPORT METHOD

(71) Applicant: FUJITSU LIMITED, Kawasaki-shi (JP)

(72) Inventors: Yasuhiro AOKI, Kawasaki (JP); Masami Mizutani, Kawasaki (JP)

(73) Assignee: FUJITSU LIMITED, Kawasaki-shi (JP)

(21) Appl. No.: 14/881,638

(22) Filed: Oct. 13, 2015

(30) Foreign Application Priority Data
Nov. 28, 2014 (JP) 2014-242556

(51) Int. Cl. B60Q 9/00

(52) U.S. Cl. CPC B60Q 9/008

(57) ABSTRACT

A driving support device for supporting driving of a vehicle by a driver, includes: a memory; and a processor coupled to the memory and configured to: determine a danger level indicating a level of danger regarding a target object, based on at least one of a relative velocity of the target object with respect to the vehicle and a relative distance between the vehicle and the target object, determine, based on information of a trajectory of a line of sight of the driver, an evaluation value indicating a first probability at which the driver becomes aware of the target object, and determine, based on the danger level and the evaluation value, a form of notifying the driver of the target object.

### CROSS-REFERENCE TO RELATED APPLICATION

This application is based upon and claims the benefit of priority of the prior Japanese Patent Application No. 2014-242556, filed on Nov. 28, 2014, the entire contents of which are incorporated herein by reference.

### FIELD

The embodiment discussed herein is related to a technique for supporting driving by a driver.

### BACKGROUND

There is a technique for supporting driving by presenting information of a region (including a region located on rear lateral sides of a vehicle) located on the rear side of the vehicle to a driver who drives the vehicle. As a related technique, a technique has been proposed, which provides an alert in consideration of results of an operation of a vehicle located on a rear lateral side of a target vehicle and human psychological characteristics of decision by a driver of the target vehicle.

In addition, another technique has been proposed, which changes a luminance level of a headup display image displayed on a windshield based on a frequency at which a driver looks at the headup display image.

In addition, another technique has been disclosed, which superimposes and displays, on an image of a region located on a rear lateral side of a target vehicle, a mark indicating at least any of a reduced distance between the target vehicle and another vehicle traveling on a lane different from a lane on which the target vehicle travels and an increased distance between the target vehicle and the other vehicle.

These techniques are disclosed in, for example, Japanese Laid-open Patent Publications Nos. 8-058503, 7-061257, and 2008-015758.

### SUMMARY

According to an aspect of the invention, a driving support device for supporting driving of a vehicle by a driver, includes: a memory; and a processor coupled to the memory and configured to: determine a danger level indicating a level of danger regarding a target object, based on at least one of a relative velocity of the target object with respect to the vehicle and a relative distance between the vehicle and the target object, determine, based on information of a trajectory of a line of sight of the driver, an evaluation value indicating a first probability at which the driver becomes aware of the target object, and determine, based on the danger level and the evaluation value, a form of notifying the driver of the target object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a vehicle and a viewing angle of a camera;

FIG. 2 is a functional block diagram illustrating an example of a driving support device;

FIGS. 3A, 3B, and 3C are diagrams illustrating an example of TTCs, inter-vehicle distances, and relative velocities and danger levels;

FIG. 4 is a flowchart of an example of a process of determining a danger level;

FIG. 5 is a first flowchart of an example of a process of determining awareness;

FIG. 6 is a second flowchart of the example of the process of determining awareness;

FIG. 7 is a flowchart of an example of a process of evaluating risk sensitivity;

FIG. 8 is a flowchart of an example of a process of highlighting an image part;

FIGS. 9A, 9B, 9C, and 9D are diagrams illustrating a first example of a video image displayed on a monitor;

FIGS. 10A, 10B, 10C, and 10D are diagrams illustrating a second example of the video image displayed on the monitor;

FIGS. 11A, 11B, 11C, and 11D are diagrams illustrating a third example of the video image displayed on the monitor;

FIG. 12 is a flowchart of a process of determining awareness according to another example;

FIG. 13 is a flowchart of an example of a process of evaluating risk sensitivity according to the other example;

FIG. 14 is a diagram illustrating an example of a vehicle having three cameras and viewing angles of the three cameras;

FIG. 15 is a functional block diagram illustrating an example of the driving support device according to the example illustrated in FIG. 14;

FIG. 16 is a diagram illustrating an example of a vehicle having two cameras and viewing angles of the two cameras;

FIG. 17 is a functional block diagram illustrating an example of the driving support device according to the example illustrated in FIG. 16; and

FIG. 18 is a diagram illustrating an example of a hardware configuration of the driving support device.

### DESCRIPTION OF EMBODIMENT

Highlighting an image part that is included in a video image displayed on a monitor installed at a driver's seat of a certain vehicle and depicts another vehicle located on the rear side of the certain vehicle promotes a driver of the certain vehicle to become aware of the other vehicle located on the rear side of the certain vehicle. In this case, the present inventors found that it was preferable to promote the driver to appropriately become aware of the other vehicle based on the easiness of the awareness by the driver by changing a form of highlighting the image part based on how the driver easily become aware of the other vehicle located on the rear side of the certain vehicle.

According to an aspect, an object of techniques disclosed in an embodiment is to promote a driver of a certain vehicle to appropriately become aware of danger from another vehicle located on the rear side of the certain vehicle.

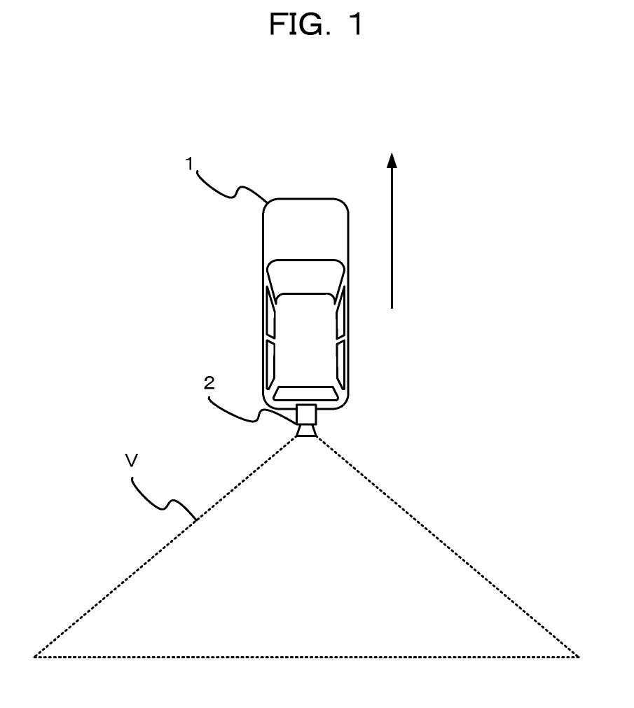

Hereinafter, the embodiment is described with reference to the accompanying drawings. FIG. 1 illustrates an example of a vehicle 1 and a viewing angle V of a camera 2. The vehicle 1 may be a car, for example. The vehicle 1 may be a vehicle other than cars or may be a transporting vehicle such as a dump truck. The vehicle 1 travels in a direction indicated by an arrow illustrated in FIG. 1.

Hereinafter, the vehicle 1 that is driven by a driver is referred to as a target vehicle, and another vehicle 1 that travels on the rear side of the target vehicle is referred to as a rear-side vehicle. The rear-side vehicle is driven by another person. The embodiment assumes that the target vehicle and the rear-side vehicle travel on different lanes. The target vehicle and the rear-side vehicle may travel on the same lane. In addition, the number of lanes is not limited.

The vehicle 1 has the camera 2 (also referred to as back camera in some cases) configured to image a region located on the rear side of the vehicle 1 at a viewing angle V. The camera 2 may use a wide-angle lens and thereby acquire an image of a region located on the rear side of the vehicle 1 at a large angle.

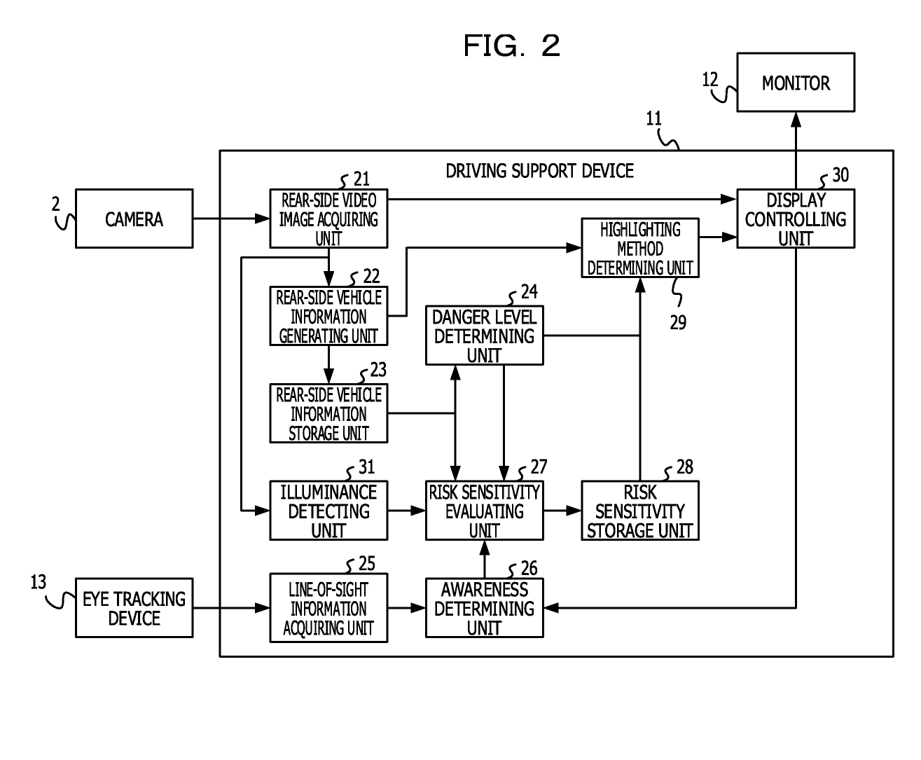

FIG. 2 illustrates an example of a driving support device 11 installed in the vehicle 1. The driving support device 11 is connected to the camera 2, a monitor 12, and an eye tracking device 13. The monitor 12 is a display device installed near a driver's seat in the vehicle 1. For example, the monitor 12 may be installed at a side portion of an instrument panel located at the driver's seat. The instrument panel is configured to display indicators such as a fuel indicator and a water temperature indicator.

The eye tracking device 13 is configured to detect the line of sight of the driver of the vehicle 1. The eye tracking device 13 may detect the line of sight of the driver by an arbitrary method. For example, the eye tracking device 13 may detect the line of sight of the driver based on the positions of the irises of the driver with respect to the inner corners of the eyes of the driver. Alternatively, the eye tracking device 13 may use infrared rays to detect the line of sight of the driver based on the positions of the pupils of the driver with respect to corneal reflections.

The driving support device 11 illustrated in the example of FIG. 2 includes a rear-side video image acquiring unit 21, a rear-side vehicle information generating unit 22, a rear-side vehicle information storage unit 23, a danger level determining unit 24, a line-of-sight information acquiring unit 25, an awareness determining unit 26, a risk sensitivity evaluating unit 27, a risk sensitivity storage unit 28, a highlighting method determining unit 29, a display controlling unit 30, and an illuminance detector 31.

The rear-side video image acquiring unit 21 acquires a video image acquired by the camera 2 and depicting a region located on the rear side of the vehicle 1. For example, the camera 2 acquires the video image of the rear-side region at a predetermined frame rate, and the rear-side video image acquiring unit 21 acquires the video image of the rear-side region at the predetermined frame rate. The rear-side video image acquiring unit 21 is an example of an acquiring unit.

The rear-side vehicle information generating unit 22 detects the other vehicle traveling on the rear side of the target vehicle based on the acquired video image of the region located on the rear side of the target vehicle. For example, the rear-side vehicle information generating unit 22 may use a method of detecting a moving object by template matching and thereby detect the rear-side vehicle depicted in the video image. Alternatively, the rear-side vehicle information generating unit 22 may use a method of detecting a moving object by optical flow, for example.

The rear-side vehicle information generating unit 22 generates information on the rear-side vehicle. The rear-side vehicle information generating unit 22 detects that the rear-side vehicle appeared in the video image acquired by the rear-side video image acquiring unit 21. The rear-side vehicle information generating unit 22 causes a time Tb (hereinafter referred to as appearance time Tb) when the rear-side vehicle appeared in the video image to be stored in the rear-side vehicle information storage unit 23.

In addition, the rear-side vehicle information generating unit 22 detects, based on the video image acquired by the rear-side video image acquiring unit 21, that the rear-side vehicle overtook the target vehicle. The rear-side vehicle information generating unit 22 causes a time Te (hereinafter referred to as overtaking time Te) when the rear-side vehicle overtook the target vehicle to be stored in the rear-side vehicle information storage unit 23.

The rear-side vehicle information generating unit 22 calculates an inter-vehicle distance L between the target vehicle and the rear-side vehicle in the traveling direction. For example, since the rear-side vehicle exists on a road surface, the rear-side vehicle information generating unit 22 may calculate the inter-vehicle distance L between the target vehicle and the rear-side vehicle by measuring actual distances between points on the road surface in a video image in advance. The inter-vehicle distance L indicates a relative distance between the traveling target vehicle and the traveling rear-side vehicle in the traveling direction.

The rear-side vehicle information generating unit 22 calculates a relative velocity V of the rear-side vehicle to the target vehicle based on a change, made between two continuous frames acquired by the camera 2, in the inter-vehicle distance L. If the relative velocity V is positive, the positive relative velocity V indicates that the rear-side vehicle approaches the target vehicle. If the relative velocity V is negative, the negative relative velocity V indicates that the rear-side vehicle moves away from the target vehicle. A method of calculating the inter-vehicle distance L and a method of calculating the relative velocity V are not limited to the aforementioned methods.

The rear-side vehicle information storage unit 23 stores rear-side vehicle information generated by the rear-side vehicle information generating unit 22 and including the appearance time Tb, the overtaking time Te, the inter-vehicle distance L, and the relative velocity V. The rear-side vehicle information generating unit 22 updates the rear-side vehicle information stored in the rear-side vehicle information storage unit 23 at predetermined times. The rear-side vehicle information storage unit 23 may store other information.

The embodiment describes an example in which after the rear-side vehicle overtakes the target vehicle, the rear-side vehicle information generating unit 22 updates the rear-side vehicle information stored in the rear-side vehicle information storage unit 23. The times when the rear-side vehicle information generating unit 22 updates the rear-side vehicle information are not limited to the predetermined times. For example, the rear-side vehicle information generating unit 22 may periodically update the rear-side vehicle information during driving.

The danger level determining unit 24 determines a danger level indicating the level of danger to the target vehicle from the rear-side vehicle. The danger level determining unit 24 is an example of a first determining unit. The danger level determining unit 24 determines the danger level based on at least one of the inter-vehicle distance L, the relative velocity V, and a collision margin time. The collision margin time is also referred to as a time to collision (TTC). Hereinafter, the collision margin time is referred to as the TTC.

If the target vehicle and the rear-side vehicle travel on the same lane, the TTC is a time that elapses until the inter-vehicle distance L between the target vehicle and the rear-side vehicle becomes 0. The collision margin time or the TTC is a value obtained by dividing the inter-vehicle distance L by the relative velocity V (TTC=L/V). Thus, the TTC is a value based on the inter-vehicle distance L and the relative velocity V.

For example, the danger level determining unit 24 may determine a value of the TTC as the danger level. The value of the TTC is a time. If the TTC is 6 seconds, the danger level determining unit 24 may determine the danger level as 6.

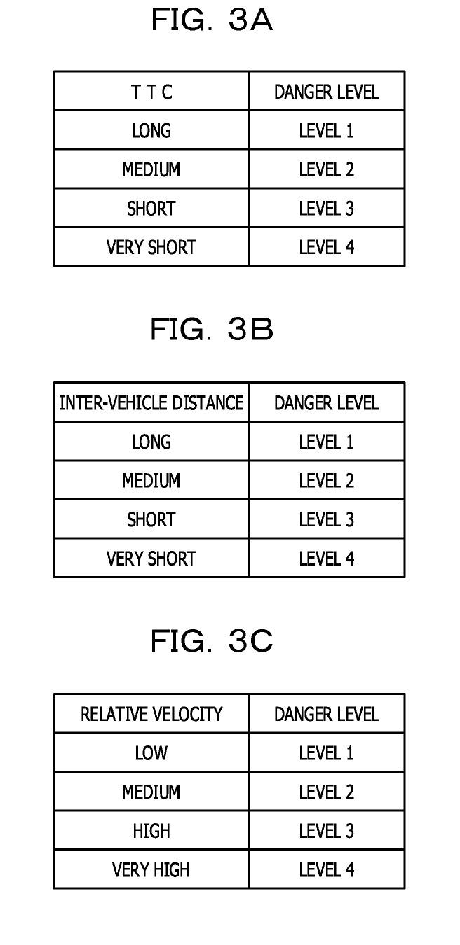

In the embodiment, the danger level determining unit 24 classifies the danger level into multiple levels based on a predetermined threshold. The threshold may be set in the danger level determining unit 24 in advance. FIG. 3A illustrates an example of association relationships between TTCs and danger levels.

The danger level determining unit 24 may associate the danger levels with inter-vehicle distances L. The longer the inter-vehicle distance L, the lower the danger level. The shorter the inter-vehicle distance L, the higher the danger level. FIG. 3B illustrates an example of association relationships between the inter-vehicle distances L and the danger levels.

The danger level determining unit 24 may associate the danger levels with relative velocities V. The lower the relative velocity V, the lower the danger level. The higher the relative velocity V, the higher the danger level. FIG. 3C illustrates an example of association relationships between the relative velocities V and the danger levels.

In the examples illustrated in FIGS. 3A to 3C, the danger level is classified into the four levels. The number of levels into which the danger level is classified is not limited to 4. If the danger level is 1, the danger level indicates that the danger is relatively low. The higher the danger level, the higher the danger. Thus, if the danger level is 4, the danger level is highest.

If the TTC is long, a time that elapses until the target vehicle and the rear-side vehicle collide with each other is long. Thus, if the TTC is long, the danger level is 1. For example, if the TTC is 6 seconds or longer, the danger level may be 1.

As the TTC becomes shorter, the time that elapses until the target vehicle and the rear-side vehicle collide with each other becomes shorter. Thus, if the TTC is medium (for example, if 4 seconds≦TTC<6 seconds), the danger level may be 2. If the TTC is short (for example, if 2 seconds≦TTC<4 seconds), the danger level may be 3. If the TTC is very short (for example, if 0 seconds<TTC<2 seconds), the danger level may be 4.

As described above, the danger level determining unit 24 may determine the danger level based on two or all of the TTC, the inter-vehicle distance L, and the relative velocity V. For example, as the relative velocity V becomes closer to 0, the TTC becomes longer. If the relative velocity V becomes 0, the TTC becomes infinite. Thus, if the TTC is used as a standard value, the danger level to be determined by the danger level determining unit 24 is low. Thus, the danger level is 1.

It is assumed that the rear-side vehicle approaches the target vehicle. In this case, the inter-vehicle distance L becomes very small. In a case where the inter-vehicle distance L is very small and the driver of the target vehicle performs an operation of causing the target vehicle to rapidly decelerate or the driver of the rear-side vehicle performs an operation of causing the rear-side vehicle to rapidly accelerate, even if the danger level based on the TTC is 1, the actual danger is high.

In this case, the danger level determining unit 24 uses a higher one of the danger level based on the TTC and the danger level based on the inter-vehicle distance L. Thus, even if the danger level based on the TTC indicates safety, the danger level based on the inter-vehicle distance L may indicate danger. Thus, the danger level determining unit 24 selects the higher danger level based on the inter-vehicle distance L and thereby may select the danger level based on safety.

The line of sight is detected by the eye tracking device 13 and the line-of-sight information acquiring unit 25 acquires information (hereinafter referred to as line-of-sight information) of the line of sight of the driver. The line-of-sight information acquired by the line-of-sight information acquiring unit 25 includes a trajectory of the line of sight of the driver.

When the image part is highlighted on the video image displayed on the monitor 12, the awareness determining unit 26 determines the awareness of the highlighted image part by the driver. The awareness determining unit 26 acquires the line-of-sight information from the line-of-sight information acquiring unit 25 and determines the awareness by the driver based on the trajectory, indicated by the acquired line-of-sight information, of the line of sight. The awareness determining unit 26 is an example of a second determining unit.

For example, the awareness determining unit 26 determines, based on the trajectory, indicated by the acquired line-of-sight information, of the line of sight, whether or not the driver looked at the monitor 12 within a predetermined time period from the time when the highlighted image part was displayed on the monitor 12. In addition, for example, the awareness determining unit 26 determines, based on the trajectory, indicated by the acquired line-of-sight information, of the line of sight, whether or not the driver carefully looked at the monitor 12 for a predetermined time period or whether or not the driver looked at the monitor 12 multiple times.

The risk sensitivity evaluating unit 27 evaluates how the driver easily becomes aware of danger to the driver. In the embodiment, the easiness of the awareness of the danger by the driver is referred to as risk sensitivity. The risk sensitivity evaluating unit 27 evaluates the risk sensitivity based on the danger level determined by the danger level determining unit 24 and the result of the determination made by the awareness determining unit 26. The risk sensitivity evaluating unit 27 is an example of an evaluating unit.

A correlation between the risk sensitivity and a driving skill of the driver is relatively high. However, even if the driving skill of the driver is high, the risk sensitivity of the driver may be low. For example, if the level of fatigue of the driver is high or a health condition of the driver is bad, the risk sensitivity of the driver may be low.

The risk sensitivity storage unit 28 stores the risk sensitivity evaluated by the risk sensitivity evaluating unit 27. Every time the target vehicle is overtaken by a rear-side vehicle, the risk sensitivity evaluating unit 27 evaluates the risk sensitivity of the driver and updates the risk sensitivity stored in the risk sensitivity storage unit 28.

Thus, the risk sensitivity may be updated to a level based on a condition of the driver that dynamically changes during driving. In addition, the risk sensitivity evaluating unit 27 may periodically evaluate the risk sensitivity and update the evaluated risk sensitivity.

The highlighting method determining unit 29 determines a form of highlighting the rear-side vehicle depicted in the video image, based on the danger level determined by the danger level determining unit 24 and the risk sensitivity, stored in the risk sensitivity storage unit 28, of the driver. The form of highlighting is an example of a level of highlighting. In addition, the highlighting method determining unit 29 is an example of a determining unit.

In the embodiment, the highlighting method determining unit 29 determines the form of highlighting based on the danger level and the risk sensitivity. If the danger level and the risk sensitivity are not changed, the highlighting method determining unit 29 maintains the current form of highlighting. On the other hand, if the danger level or the risk sensitivity is changed, the highlighting method determining unit 29 changes the form of highlighting.

The display controlling unit 30 superimposes, on the video image acquired by the rear-side video image acquiring unit 21, the image part highlighted in the form determined by the highlighting method determining unit 29. Then, the display controlling unit 30 controls the monitor 12 so as to cause the video image having the highlighted image part superimposed thereon to be displayed on the monitor 12. Since the video image is acquired at the predetermined frame rate, the video image having the highlighted image part superimposed thereon is displayed on the monitor 12.

### Example of Process of Generating Rear-Side Vehicle Information

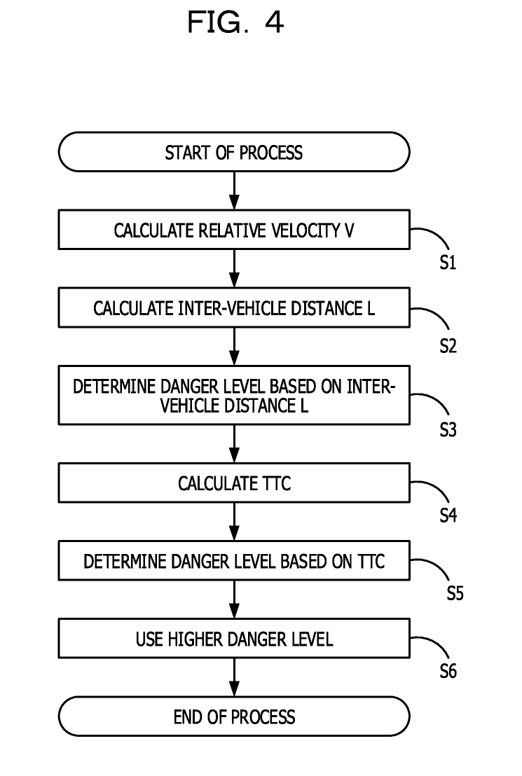

Next, an example of a process of generating the rear-side vehicle information is described with reference to a flowchart illustrated as an example in FIG. 4. The rear-side vehicle information generating unit 22 calculates the relative velocity V of the rear-side vehicle to the target vehicle based on a change, made between continuous frames acquired by the camera 2, in the inter-vehicle distance between the target vehicle and the rear-side vehicle (in step S1).

In addition, as described above, the rear-side vehicle information generating unit 22 calculates the inter-vehicle distance L between the target vehicle and the rear-side vehicle (in step S2). The rear-side vehicle information storage unit 23 stores the calculated relative velocity V and the calculated inter-vehicle distance L.

The danger level determining unit 24 acquires the relative velocity V and the inter-vehicle distance L from the rear-side vehicle information storage unit 23 (in step S3). Then, the danger level determining unit 24 determines the danger level based on the inter-vehicle distance L (in step S3). If the inter-vehicle distance L is long, the danger level is low. If the inter-vehicle distance L is short, the danger level is high.

The danger level determining unit 24 calculates the TTC by dividing the inter-vehicle distance L by the relative velocity V (in step S4). Then, the danger level determining unit 24 determines the danger level based on the TTC (in step S5). If the TTC is long, the danger level is low. If the TTC is short, the danger level is high.

The danger level determining unit 24 determines which one of the danger level based on the inter-vehicle distance L and the danger level based on the TTC is higher than the other. The danger level determining unit 24 uses, as the danger level, higher one of the danger level based on the inter-vehicle distance L and the danger level based on the TTC (in step S6). As described above, the danger level determining unit 24 may use, as the danger level, the highest danger level among the danger level based on the inter-vehicle distance L, the danger level based on the TTC, and the danger level based on the relative velocity V.

### Example of Process of Determining Awareness

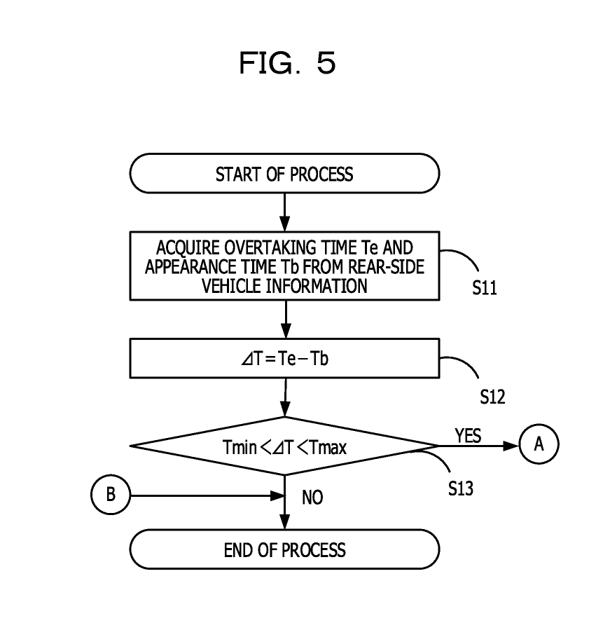

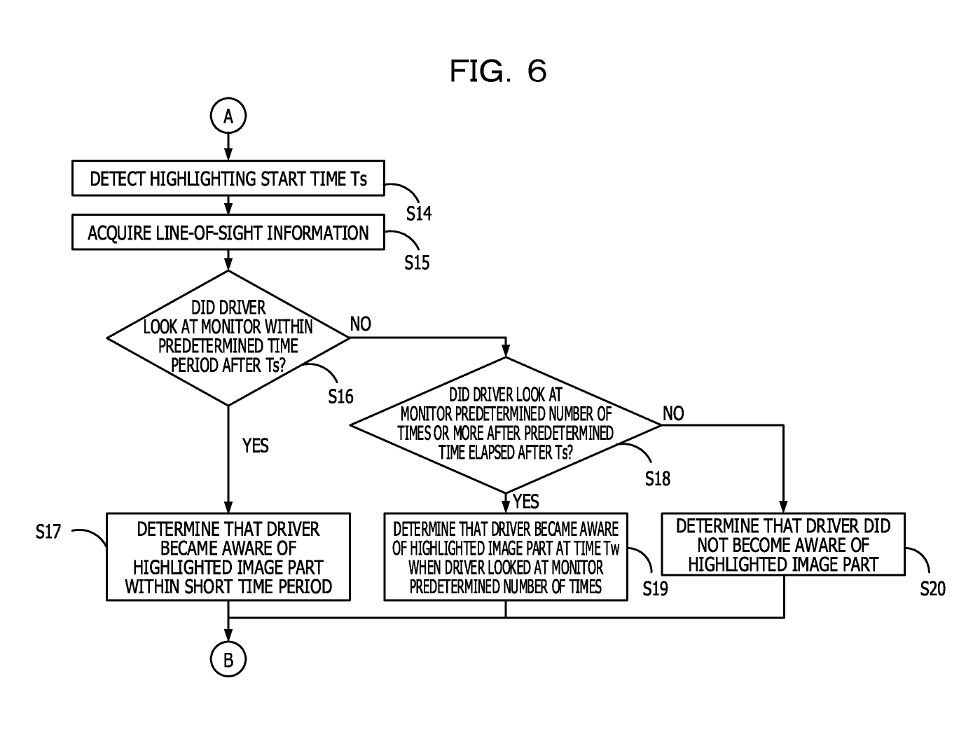

Next, a process of determining the awareness is described with reference to flowcharts illustrated as an example in FIGS. 5 and 6. The process of determining the awareness is executed in order to evaluate the risk sensitivity. The risk sensitivity evaluating unit 27 acquires the overtaking time Te and the appearance time Tb from the rear-side vehicle information stored in the rear-side vehicle information storage unit 23 (in step S11).

The risk sensitivity evaluating unit 27 subtracts the appearance time Tb from the overtaking time Te and thereby acquires a differential time ΔT (=Te−Tb) (in step S12). The differential time ΔT is a time period from the time when the rear-side vehicle appears in the video image to the time when the rear-side vehicle overtakes the target vehicle. The fact that the rear-side vehicle overtakes the target vehicle may be detected based on the fact that the rear-side vehicle depicted in the video image gradually increases in size and disappears from the video image.

If the differential time ΔT is large, the rear-side vehicle takes a long time to overtake the target vehicle. On the other hand, if the differential time ΔT is small, the rear-side vehicle takes a short time to overtake the target vehicle. If the rear-side vehicle takes a short time to overtake the target vehicle, it may be difficult for the driver of the target vehicle to sufficiently confirm the rear-side vehicle regardless of the risk sensitivity.

If the rear-side vehicle takes a short time to overtake the target vehicle, the highlighted image part superimposed on the video image displayed on the monitor 12 is displayed in a short time and disappears. Thus, even if the risk sensitivity of the driver is high, the driver may not become aware of the highlighted image part. In this case, the accuracy of the risk sensitivity, evaluated by the risk sensitivity evaluating unit 27, of the driver may be reduced. Thus, if the differential time AT is larger than a first threshold Tmin set in advance, the risk sensitivity evaluating unit 27 evaluates the risk sensitivity.

On the other hand, if the differential time ΔT is sufficiently large, the highlighted image part is displayed on the monitor 12 for a long time. In this case, even if the risk sensitivity of the driver is low, the driver is likely to become aware of the highlighted image part and the risk sensitivity of the driver may be evaluated as a high level. Thus, if the differential time ΔT is smaller than a second threshold Tmax set in advance, the risk sensitivity evaluating unit 27 evaluates the risk sensitivity.

In the embodiment, the risk sensitivity evaluating unit 27 determines whether or not the differential time ΔT satisfies Tmin<ΔT<Tmax (in step S13). It is preferable that the first threshold Tmin and the second threshold Tmax be set to times that enable the risk sensitivity to be appropriately evaluated.

If the differential time ΔT does not satisfy Tmin<ΔT<Tmax (No in step S13), the risk sensitivity evaluating unit 27 does not evaluate the risk sensitivity. In this case, the process of determining the awareness is not executed. Thus, the process is terminated.

On the other hand, if the differential time AT satisfies Tmin<ΔT<Tmax (Yes in step S13), the process of determining the awareness is executed in order to evaluate the risk sensitivity. Thus, the process proceeds to “A”. Processes after “A” are executed by the awareness determining unit 26.

The processes after “A” are described with reference to FIG. 6. The awareness determining unit 26 detects a time (hereinafter referred to as highlighting start time Ts) when the display controlling unit 30 starts highlighting the image part (in step S14).

The awareness determining unit 26 acquires the information of the line of sight of the driver from the line-of-sight information acquiring unit 25 (in step S15). The awareness determining unit 26 determines, based on the trajectory, indicated by the line-of-sight information, of the line of sight, whether or not the driver looked at the monitor 12 within a predetermined time period after the highlighting start time Ts (in step S16).

For example, the awareness determining unit 26 detects the highlighting start time Ts, measures the passage of time from the highlighting start time Ts, and determines whether or not the line of sight of the driver is placed on the monitor 12 within the predetermined time period. The predetermined time period may be set to an arbitrary value.

When the rear-side vehicle displayed on the monitor 12 is highlighted, the video image displayed on the monitor 12 noticeably changes. When the video image displayed on the monitor 12 noticeably changes, the driver is likely to look at the monitor 12.

If the awareness determining unit 26 determines that the driver looked at the monitor 12 within the predetermined time period after the highlighting start time Ts (Yes in step S16), the awareness determining unit 26 determines that the driver became aware of the highlighted image part within a short time period (in step S17).

On the other hand, if the awareness determining unit 26 determines that the driver did not look at the monitor 12 within the predetermined time period after the highlighting start time Ts (No in step S16), the awareness determining unit 26 determines whether or not the driver looked at the monitor 12 a predetermined number of times or more after the predetermined time period elapses (in step S18). Whether or not the driver looked at the monitor 12 is based on the trajectory of the line of sight that is indicated by the line-of-sight information.

In the embodiment, as the rear-side vehicle approaches the target vehicle, the image part is highlighted more strongly or the level of highlighting is higher. Thus, even if the driver does not become aware of the highlighted image part in a short time period, the driver may look at the monitor 12 several times after the predetermined time period elapses after the highlighting start time Ts.

It is assumed that the driver looked at the monitor 12 a predetermined number of times or more after the predetermined time period elapsed after the highlighting start time Ts. In this case (Yes in step S18), the awareness determining unit 26 determines that the driver became aware of the highlighted image part at a time (hereinafter referred to as awareness time Tw) when the driver looked at the monitor 12 the predetermined number of times (in step S19).

The predetermined number of times may be arbitrary. For example, the predetermined number of times may be 1 or 2. However, even if the driver does not become aware of the rear-side vehicle, the trajectory of the line of sight of the driver may be incidentally located on the monitor 12. It is, therefore, preferable that the predetermined number of times be not 1 and be two or more.

The awareness time Tw is the time when the trajectory of the line of sight of the driver is located on the monitor 12 for the predetermined number-th time. For example, if the predetermined number of times is 2, the time when the trajectory of the line of sight of the driver is located on the monitor 12 for the second time is the awareness time Tw. The time when the trajectory of the line of sight of the driver is located on the monitor 12 is the time when the driver looks at the monitor 12.

If the trajectory of the line of sight of the driver was not located on the monitor 12 the predetermined number of times or more after the predetermined time period elapsed after the highlighting start time Ts, or if the driver did not look at the monitor 12 the predetermined number of times or more after the predetermined time period elapsed after the highlighting start time Ts (No in step S18), the awareness determining unit 26 determines that the driver did not become aware of the highlighted image part (in step S20).

The awareness determining unit 26 makes the aforementioned determination. When the determination made by the awareness determining unit 26 is terminated, the process returns to “B” illustrated in FIG. 5 through “B” illustrated in FIG. 6 and is terminated. In the aforementioned manner, the awareness determining unit 26 determines the awareness by the driver.

Thus, in the example illustrated in FIG. 6, the awareness determining unit 26 uses three levels to determine the awareness by the driver. For example, in step S20, the awareness determining unit 26 may determine the level of the awareness as 0.

In addition, in step S19, the awareness determining unit 26 may determine the level of the awareness as 1. In step S17, the awareness determining unit 26 may determine the level of the awareness as 2. The number of levels of the awareness is not limited to 3. The number of levels of the awareness may be 2 or may be 4 or more.

### Example of Process of Evaluating Risk Sensitivity

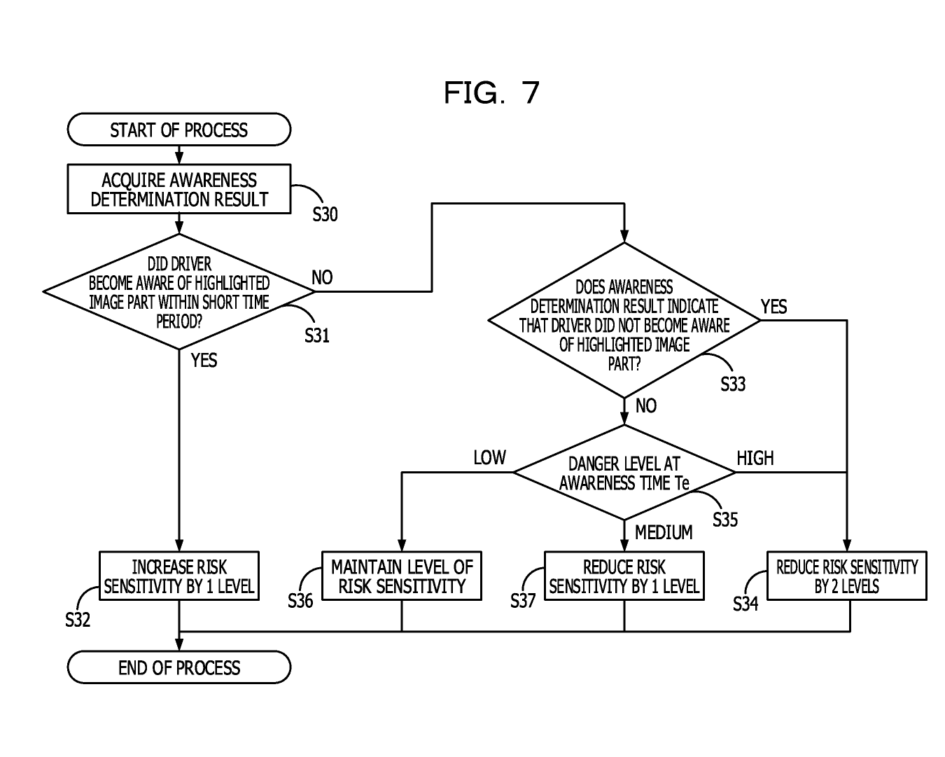

Next, an example of a process of evaluating the risk sensitivity is described with reference to a flowchart illustrated in FIG. 7. The risk sensitivity evaluating unit 27 acquires the result of the determination made by the awareness determination unit 26 (in step S30). The result of the determination is hereinafter referred to as an awareness determination result.

In the embodiment, the risk sensitivity evaluating unit 27 evaluates the risk sensitivity using three levels, a “high” level, a “medium” level, and a “low” level. The risk sensitivity may be evaluated using four or more levels or may be evaluated using two levels. The evaluated risk sensitivity is stored in the risk sensitivity storage unit 28. The embodiment assumes that an initial value of the risk sensitivity of the driver is the “medium” level.

As described above, the awareness determining unit 26 determines that the awareness determination result indicates that “the driver became aware of the highlighted image part within a short time period”, or that “the driver became aware of the highlighted image part at the time Tw when the driver looked at the monitor 12 the predetermined number of times”, or that “the driver did not become aware of the highlighted image part”.

The risk sensitivity evaluating unit 27 determines whether or not the awareness determination result indicates that “the driver became aware of the highlighted image part within the short time period” (in step S31). If the awareness determination result indicates that “the driver became aware of the highlighted image part within the short time period” (Yes in step S31), the risk sensitivity evaluating unit 27 increases the risk sensitivity by 1 level (in step S32). Specifically, the level that indicates the easiness of the awareness is increased by 1.

On the other hand, if the awareness determination result does not indicate that “the driver became aware of the highlighted image part within the short time period” (No in step S31), the risk sensitivity evaluating unit 27 determines whether or not the awareness determination result indicates that “the driver did not become aware of the highlighted image part” (in step S33).

If the awareness determination result indicates that “the driver did not become aware of the highlighted image part”, the driver did not become aware of the highlighted image part displayed on the monitor 12 within a time period from the appearance time Tb to the overtaking time Te. If the awareness determination result indicates that “the driver did not become aware of the highlighted image part” (Yes in step S33), the risk sensitivity evaluating unit 27 reduces the level of the risk sensitivity of the driver by 2 levels (in step S34).

For example, even if the risk sensitivity, stored in the risk sensitivity storage unit 28, of the driver is at the “high” level, the risk sensitivity evaluating unit 27 reduces the level of the risk sensitivity by 2 levels and thereby sets the level of the risk sensitivity to the “low” level. If the risk sensitivity, stored in the risk sensitivity storage unit 28, of the driver is at the “medium” level, the risk sensitivity evaluating unit 27 reduces the level of the risk sensitivity by 1 level and thereby sets the level of the risk sensitivity to the “low” level. Specifically, the level that indicates the easiness of the awareness is reduced to the “low” level.

On the other hand, if the awareness determination result does not indicate that “the driver did not become aware of the highlighted image part” (No in step S33), the awareness determination result indicates that “the driver became aware of the highlighted image part at the time Tw when the driver looked at the monitor 12 the predetermined number of times”. In this case, the risk sensitivity evaluating unit 27 evaluates the risk sensitivity based on the danger level at the time Tw when the driver became aware of the highlighted image part for the predetermined number-th time (in step S35).

If the danger level at the awareness time Tw is the level 1 or 2 (hereinafter referred to as “low” level), the risk sensitivity evaluating unit 27 maintains the current level of the risk sensitivity (in step S36).

If the danger level is the “low” level, the image part displayed on the monitor 12 is weakly highlighted and the driver is unlikely to become aware of the highlighted image part. Thus, the risk sensitivity evaluating unit 27 maintains the current level of the risk sensitivity stored in the risk sensitivity storage unit 28.

If the danger level at the awareness time Tw is the level 3 (hereinafter referred to as “medium” level), the risk sensitivity evaluating unit 27 reduces the current level of the risk sensitivity by 1 level (in step S37). If the danger level at the awareness time Tw is the “medium” level, the image part displayed on the monitor 12 is relatively strongly highlighted. Thus, the risk sensitivity evaluating unit 27 reduces the level of the risk sensitivity by 1 level.

If the danger level at the awareness time Tw is the level 4 (hereinafter referred to as “high” level), the risk sensitivity evaluating unit 27 reduces the current level of the risk sensitivity by 2 levels (in step S34). If the danger level at the awareness time Tw is the “high” level, the image part displayed on the monitor 12 is strongly highlighted. Thus, the risk sensitivity evaluating unit 27 reduces the level of the risk sensitivity by 2 levels.

In the aforementioned manner, the risk sensitivity evaluating unit 27 evaluates the risk sensitivity of the driver. The risk sensitivity evaluating unit 27 may evaluate the risk sensitivity every time the awareness determining unit 26 determines the awareness by the driver. The awareness determining unit 26 may determine the awareness every time a rear-side vehicle appears and overtakes the target vehicle.

In this case, the risk sensitivity evaluating unit 27 may evaluate the risk sensitivity every time a rear-side vehicle overtakes the target vehicle. Thus, the risk sensitivity, stored in the risk sensitivity storage unit 28, of the driver is dynamically updated during the time when the driver drives the target vehicle.

### Example of Process of Highlighting

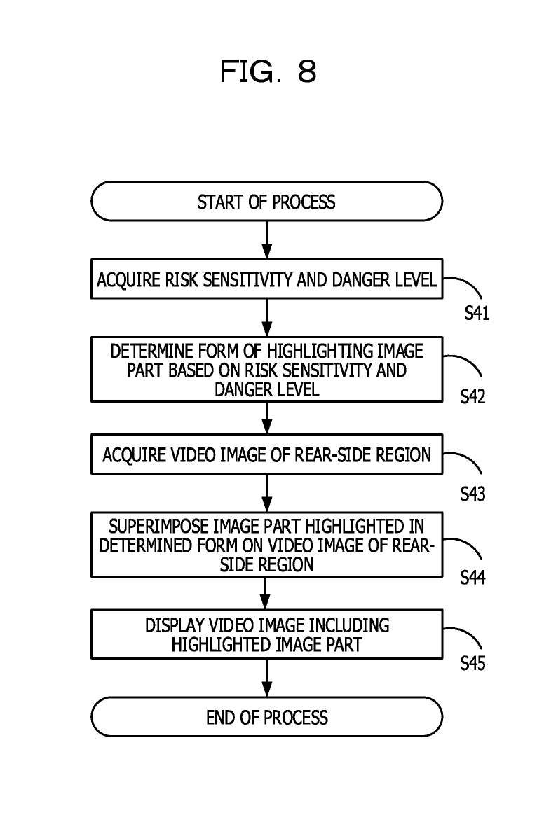

Next, an example of a process of highlighting the image part is described with reference to FIG. 8. The highlighting method determining unit 29 acquires the risk sensitivity from the risk sensitivity storage unit 28 and acquires the danger level determined by the danger level determining unit 24 (in step S41)

The highlighting method determining unit 29 determines, based on the acquired risk sensitivity and the acquired danger level, the form of highlighting the image part to be displayed on the monitor 12 (in step S42). In the embodiment, the highlighting method determining unit 29 determines, based on the acquired risk sensitivity and the acquired danger level, the form of highlighting the image part.

If the risk sensitivity of the driver is at the high level, and the image part displayed on the monitor 12 is strongly highlighted, the visibility of the video image may be reduced rather than being increased, and the highlighted image part may be bothersome for the driver. On the other hand, if the risk sensitivity of the driver is at the low level, it is preferable that the image part displayed on the monitor 12 be strongly highlighted.

In addition, if the danger level is low and the image part displayed on the monitor 12 is strongly highlighted, the visibility from the driver may be reduced. Thus, if the danger level is low, it is preferable that the image part displayed on the monitor 12 be weakly highlighted. On the other hand, if the danger level is high, it is preferable that the image part displayed on the monitor 12 be strongly highlighted.

The display controlling unit 30 receives the video image acquired by the rear-side video image acquiring unit 21 and depicting the region located on the rear side of the target vehicle (in step S43). The display controlling unit 30 superimposes, on the video image of the rear-side region, the image part that is highlighted in the form determined by the highlighting method determining unit 29 (in step S44).

Then, the display controlling unit 30 displays, on the monitor 12, the video image having the highlighted image part superimposed thereon (in step S45). The video image acquired by the camera 2 is displayed on the monitor 12 in real time. Then, the highlighted image part is superimposed and displayed on the video image depicting the rear-side vehicle.

### Example of Video Image Displayed on Monitor

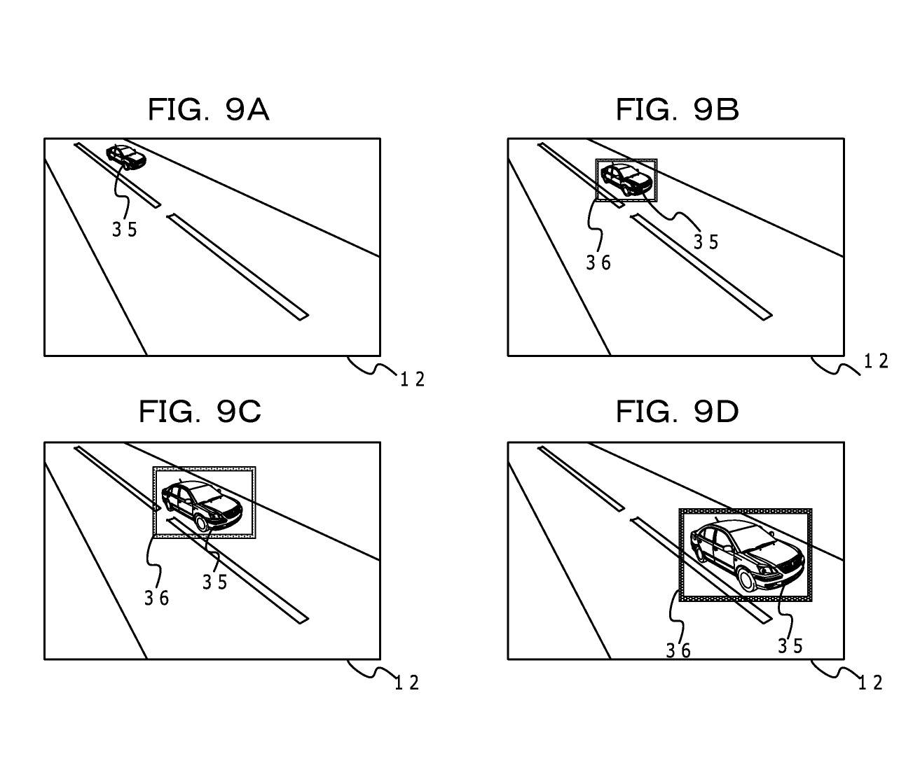

Next, examples of the video image displayed on the monitor 12 are described with reference to FIGS. 9A to 11D. FIGS. 9A, 9B, 9C, and 9D illustrate an example of the video image having the highlighted image part superimposed thereon based on the danger level when the risk sensitivity is at the “high” level.

The embodiment assumes that a rectangular frame that surrounds a rear-side vehicle 35 and is depicted on the video image is a highlighted image part 36. The highlighted image part, however, is not limited to the rectangular frame. For example, the highlighted image part may be a circular or elliptical frame surrounding the rear-side vehicle 35 depicted on the video image. Alternatively, the highlighted image part may change the form of displaying the rear-side vehicle 35 depicted on the video image.

FIGS. 9A to 9D illustrate an example of the display of the monitor 12 when the risk sensitivity of the driver is at the “high” level. In a state illustrated in FIG. 9A, the danger level is 1 and low. Thus, the highlighting method determining unit 29 does not superimpose the highlighted image part 36 on the video image. Thus, the highlighted image part 36 is not included in the video image illustrated as an example in FIG. 9A. At a time corresponding to FIG. 9A, the highlighting method determining unit 29 may cause the highlighted image part 36 to be included in the video image.

FIG. 9B illustrates an example of the video image when the danger level is 2. In a state illustrated in FIG. 9B, the rear-side vehicle 35 becomes closer to the target vehicle, compared with the state illustrated in FIG. 9A. In other words, the inter-vehicle distance L is reduced.

Thus, the highlighting method determining unit 29 superimposes the highlighted image part 36 on the video image. In the example illustrated in FIG. 9B, the risk sensitivity of the driver is at the “high” level. Thus, the highlighting method determining unit 29 determines the form of highlighting so as to ensure that the width of the frame of the highlighted image part 36 is small. In other words, the highlighting method determining unit 29 superimposes, on the video image, the image part 36 weakly highlighted.

If the risk sensitivity of the driver is at the “high” level and the width of the frame of the highlighted image part 36 is small, the driver may easily become aware of the highlighted image part 36. The frame of the highlighted image part 36 that has the small width may cause a reduction in the visibility of the video image and may be bothersome for the driver if the risk sensitivity of the driver is at the “high” level. Thus, the highlighting method determining unit 29 determines that the frame of the highlighted image part 36 that has the small width is to be superimposed.

FIG. 9C illustrates an example of the video image when the rear-side vehicle 35 becomes closer to the target vehicle, compared with the state illustrated in FIG. 9B. Since the rear-side vehicle 35 becomes closer to the target vehicle, the rear-side vehicle 35 depicted on the video image increases in size and the highlighted image part 36 increases in size.

FIG. 9D illustrates an example of the video image when the rear-side vehicle 35 becomes closer to the target vehicle, compared with the state illustrated in FIG. 9C. If the danger level is 4, the highlighting method determining unit 29 changes a color of the frame of the highlighted image part 36.

For example, in each of the states illustrated in FIGS. 9B and 9C, the highlighting method determining unit 29 may determine the color of the frame of the highlighted image part 36 to be yellow. In the state illustrated in FIG. 9D, the highlighting method determining unit 29 may determine the color of the frame of the highlighted image part 36 to be red. In the examples illustrated in FIGS. 9A to 11D, if the color of the highlighted image part 36 is yellow, the highlighted image part 36 is thinly hatched. In addition, if the color of the highlighted image part 36 is red, the highlighted image part 36 is thickly hatched.

If the danger level is 4, the danger level is highest among the four levels. Thus, if the danger level is 4, the highlighting method determining unit 29 changes the color of the frame of the highlighted image part 36 in order to have the driver recognize that the danger level is highest.

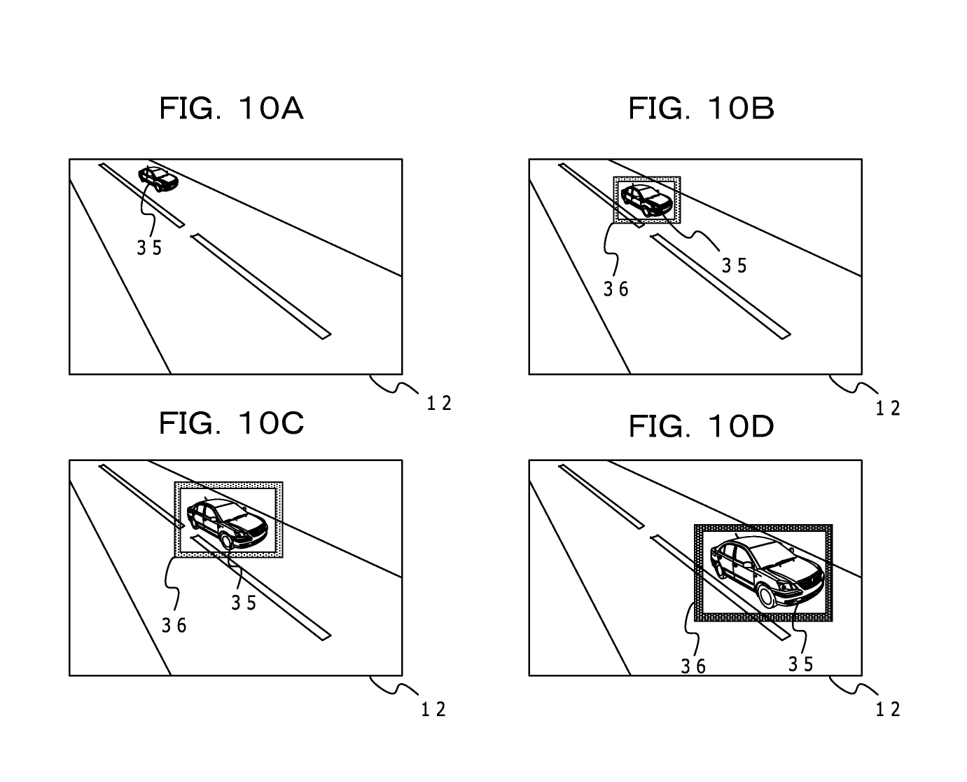

FIGS. 10A to 10D illustrate an example of the display of the monitor 12 when the risk sensitivity of the driver is at the medium level. In a state illustrated in FIG. 10A, since the danger level is 1, the highlighted image part 36 is not included in the video image displayed on the monitor 12, like the aforementioned case.

FIG. 10B illustrates an example of the video image when the danger level is 2. Since the danger level is 2, the highlighting method determining unit 29 superimposes the highlighted image part 36 on the video image. FIG. 10B illustrates an example of the display of the monitor 12 when the driver whose risk sensitivity is at the “medium” level drives the target vehicle.

Since the risk sensitivity of the driver is at the “medium” level, it is preferable that the highlighting method determining unit 29 superimpose, on the video image, the image part 36 highlighted more strongly than the image part 36 highlighted when the risk sensitivity is at the “high” level. In the example illustrated in FIG. 10B, the width of the frame of the highlighted image part 36 is larger than the width of the frame displayed in the example illustrated in FIG. 9B.

Thus, the image part 36 displayed on the monitor 12 is highlighted more strongly than the image part 36 displayed in the state illustrated in FIG. 9B. In the embodiment, the highlighting method determining unit 29 changes the width of the frame of the highlighted image part 36 based on the risk sensitivity of the driver. The embodiment, however, is not limited to this example. For example, if the risk sensitivity of the driver is at the “medium” level, the highlighting method determining unit 29 may cause the frame of the highlighted image part 36 to blink at a low speed.

FIG. 10C illustrates an example of the video image when the rear-side vehicle 35 becomes closer to the target vehicle, compared with the state illustrated in FIG. 10B. Since the rear-side vehicle 35 approaches the target vehicle, the rear-side vehicle 35 depicted on the video image increases in size and the highlighted image part 36 increases in size.

FIG. 10D illustrates an example of the video image when the rear-side vehicle 35 becomes closer to the target vehicle, compared with the state illustrated in FIG. 10C. If the danger level is 4, the highlighting method determining unit 29 changes the color of the frame of the highlighted image part 36. If the danger level is 2 or 3, the highlighting method determining unit 29 may change the color of the frame to yellow, like the aforementioned case. If the danger level is 4, the highlighting method determining unit 29 may change the color of the frame to red.

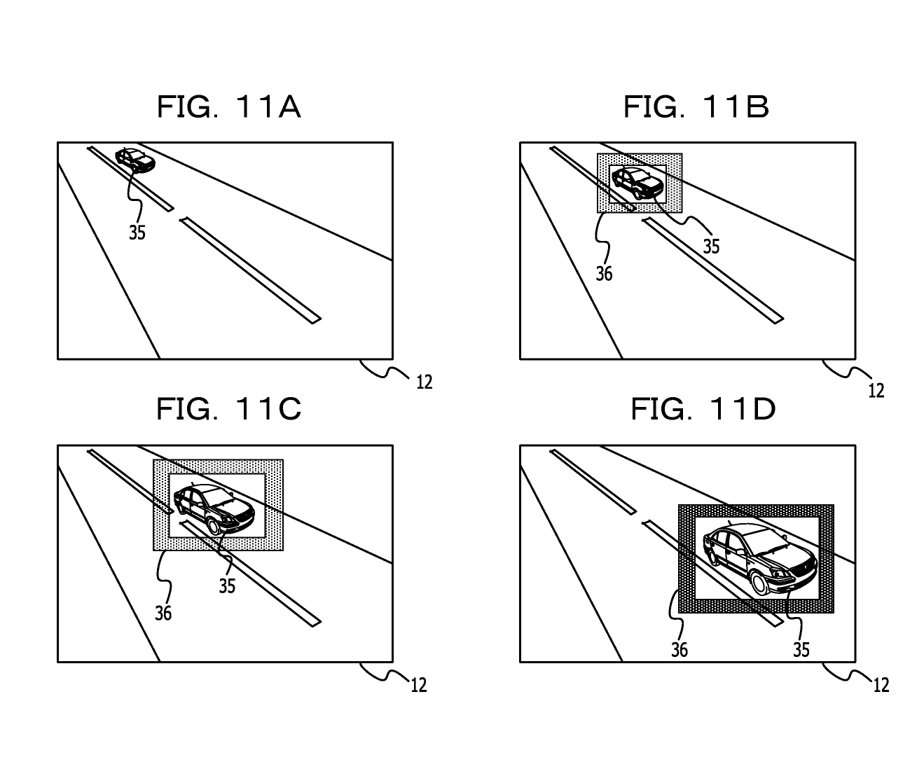

FIGS. 11A to 11D illustrate an example of the display of the monitor 12 when the risk sensitivity of the driver is at the “low” level. In a state illustrated in FIG. 11A, since the danger level is 1, the highlighted image part 36 is not included in the video image displayed on the monitor 12, like the aforementioned cases.

FIG. 11B illustrates an example of the video image when the danger level is 2. Since the danger level is 2, the highlighting method determining unit 29 superimposes the highlighted image part 36 on the video image. FIG. 11B illustrates an example of the display of the monitor 12 when the risk sensitivity of the driver is at the “low” level.

Since the risk sensitivity of the driver is at the “low” level, it is preferable that the highlighting method determining unit 29 superimpose, on the video image, the image part 36 highlighted more strongly than the image part 36 highlighted when the risk sensitivity is at the “medium” level. In the example illustrated in FIG. 11B, the width of the frame of the highlighted image part 36 is larger than the frame illustrated in the example of FIG. 10B.

Thus, the image part 36 is highlighted more strongly than the image part 36 in the state illustrated in FIG. 10B and is displayed on the monitor 12. Specifically, the width of the frame of the highlighted image part 36 is largest when the driver whose risk sensitivity is at the “low” level drives the target vehicle. The highlighting method determining unit 29 may cause the frame of the highlighted image part 36 to blink at a high speed.

FIG. 11C illustrates an example of the video image when the rear-side vehicle 35 becomes closer to the target vehicle, compared with the state illustrated in FIG. 11B. Since the rear-side vehicle 35 approaches the target vehicle, the rear-side vehicle 35 depicted in the video image increases in size and the highlighted image part 36 increases in size.

FIG. 11D illustrates an example of the video image when the rear-side vehicle 35 becomes closer to the target vehicle, compared with the state illustrated in FIG. 11C. If the danger level is 4, the highlighting method determining unit 29 changes the color of the frame of the highlighted image part 36. If the danger level is 2 or 3, the highlighting method determining unit 29 may change the color of the frame of the highlighted image part 36 to yellow, like the aforementioned cases. If the danger level is 4, the highlighting method determining unit 29 may change the color of the frame of the highlighted image part 36 to red.

### Example of Limit on Risk Sensitivity

In the aforementioned examples, the risk sensitivity evaluating unit 27 evaluates the risk sensitivity of the driver using the “high”, “medium”, and “low” levels. In this case, the risk sensitivity evaluating unit 27 may limit the levels of the risk sensitivity to be evaluated to the “medium” and “low” levels. In other words, the risk sensitivity evaluating unit 27 may limit the levels of the risk sensitivity of the driver to ensure that the level of the risk sensitivity of the driver is not evaluated as the “high” level.

For example, if the driver drives the target vehicle during night time hours, it may be more difficult for the driver to become aware of the rear-side vehicle depicted on the video image than during daytime hours. Thus, even if the risk sensitivity evaluating unit 27 may evaluate the risk sensitivity of the driver as the “high” level, the risk sensitivity evaluating unit 27 may evaluate the risk sensitivity of the driver as the “medium” level.

The illuminance detector 31 receives the video image acquired by the rear-side video image acquiring unit 21 and detects illuminance of the video image. If the illuminance is lower than a threshold set for illuminance in advance, the illuminance detector 31 detects that a region surrounding the target vehicle is dark and determines that the current time is during the night time hours. Whether or not the illuminance is low may be determined based on luminance values of pixels of the video image.

If the illuminance detector 31 determines that the current time is during the night time hours, the illuminance detector 31 notifies the risk sensitivity evaluating unit 27 that the current time is during the night time hours. When receiving the notification, the risk sensitivity evaluating unit 27 may evaluate the risk sensitivity as a level other than the “high” level. Thus, the driving support device may support the driving in a safer manner.

In addition, a driving skill of the driver may be set in the driving support device 11 in advance. If information that indicates that the driver is a beginner is set in the driving support device 11, the risk sensitivity evaluating unit 27 may evaluate the risk sensitivity as a level other than the “high” level. Thus, the driving support device may support the driving in a safer manner.

### Example of Evaluation of Risk Sensitivity Based on Careful Look

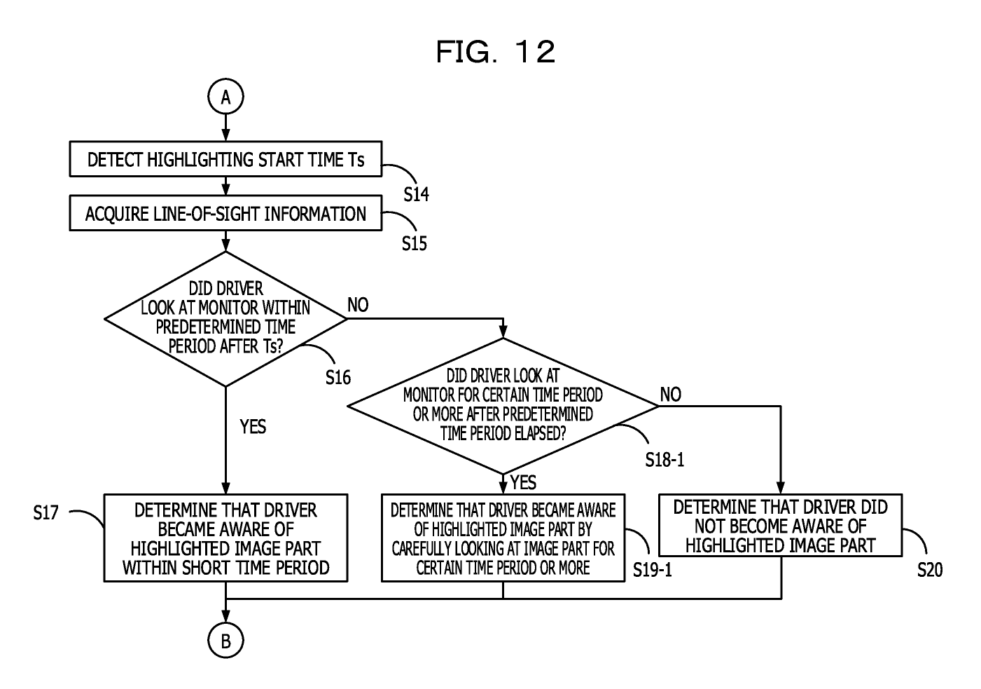

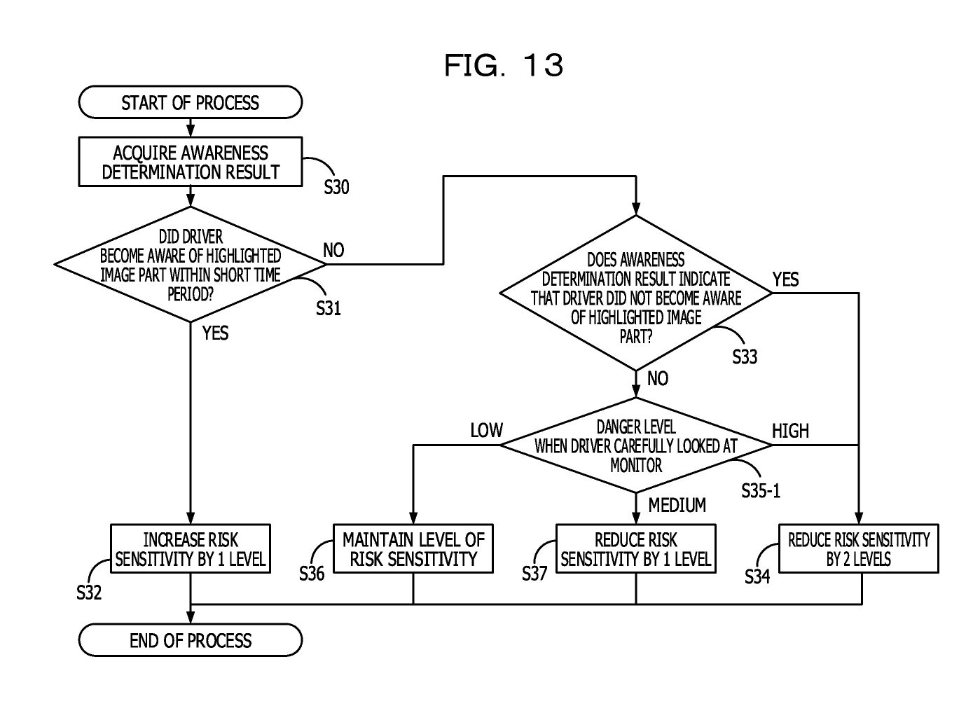

Next, another example of the evaluation of the risk sensitivity is described with reference to flowcharts illustrated in FIGS. 12 and 13. The flowchart illustrated in FIG. 12 is different in steps S18 and S19 from the aforementioned flowchart illustrated in FIG. 6.

The awareness determining unit 26 determines whether or not the driver looked at the monitor for a certain time period or more after the predetermined time period elapsed from the highlighting start time Ts (in step S18-1). Whether or not the driver looked at the monitor 12 is determined based on the trajectory, indicated by the line-of-sight information, of the line of sight.

If the trajectory of the line of sight of the driver is located on the monitor 12 for the certain time period or more, a probability at which the driver carefully looks at the highlighted image part 36 displayed on the monitor 12 is high. In this case, the awareness determining unit 26 determines that the driver carefully looked at the highlighted image part 36 for the certain time period or more and became aware of the highlighted image part 36 (in step S19-1).

The flowchart illustrated in FIG. 13 is different in step S35 from the flowchart illustrated in FIG. 7. The risk sensitivity evaluating unit 27 determines the danger level when the driver carefully looked at the monitor 12 (in step S35-1). Whether or not the driver carefully looked at the monitor 12 is determined based on the trajectory, indicated by the line-of-sight information, of the line of sight.

If the danger level when the trajectory of the line of sight of the driver is located on the monitor 12 for the certain time period or more is “low”, the risk sensitivity evaluating unit 27 maintains the level of the risk sensitivity (in step S36). If the danger level is low, the image part 36 is weakly highlighted. Even if the image part 36 is weakly highlighted, the driver becomes aware of the image part 36 and the risk sensitivity evaluating unit 27 maintains the level of the risk sensitivity.

If the danger level when the trajectory of the line of sight of the driver is located on the monitor 12 for the certain time period or more is “medium”, the risk sensitivity evaluating unit 27 reduces the level of the risk sensitivity by 1 level (in step S37). In this case, since the image part 36 displayed on the monitor 12 is relatively strongly highlighted, the risk sensitivity evaluating unit 27 reduces the level of the risk sensitivity by 1 level.

If the danger level when the trajectory of the line of sight of the driver is located on the monitor 12 for the certain time period or more is “high”, the risk sensitivity evaluating unit 27 reduces the level of the risk sensitivity by 2 levels (in step S34). If the danger level is “high”, the image part 36 is strongly highlighted. If the image part 36 is strongly highlighted and the driver does not carefully look at the monitor 12, the risk sensitivity evaluating unit 27 determines that the risk sensitivity of the driver is at the low level. Thus, the risk sensitivity evaluating unit 27 reduces the level of the risk sensitivity of the driver by 2 levels.

Thus, the risk sensitivity evaluating unit 27 may evaluate the risk sensitivity based on the number of times when the driver looked at the monitor 12. The risk sensitivity evaluating unit 27 may evaluate the risk sensitivity based on whether or not the driver carefully looked at the monitor 12 for the certain time period or more.

### Example of Use of Three Cameras

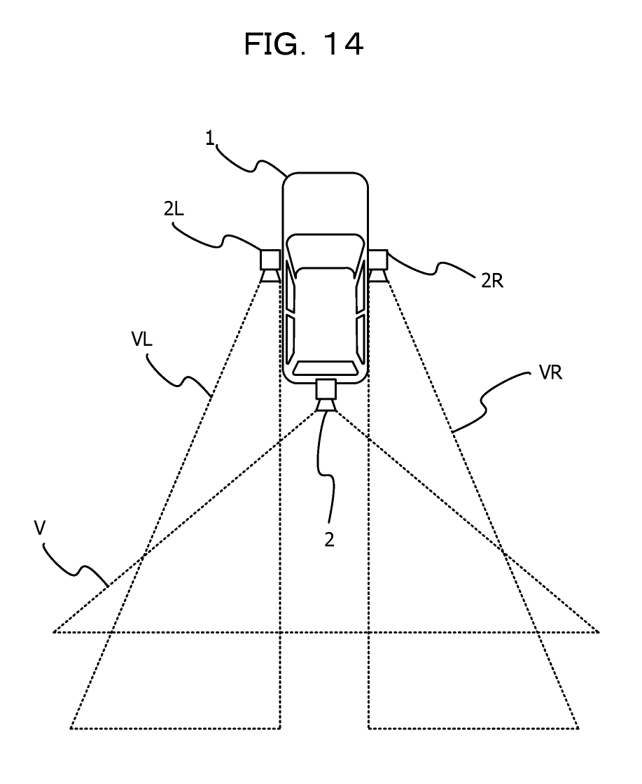

FIG. 14 illustrates an example in which three cameras are used. In the example illustrated in FIG. 14, the camera 2 (illustrated in FIG. 1) for imaging a rear-side region, a left camera 2L, and a right camera 2R are installed on the vehicle 1. The left camera 2L and the right camera 2R are installed on the front side of the vehicle 1 with respect to the camera 2 (or installed, for example, on both sides of the driver's seat).

The left camera 2L images a region located on the left rear side of the vehicle 1. The right camera 2R images a region located on the right rear side of the vehicle 1. The left camera 2L has a viewing angle VL illustrated in the example of FIG. 14, while the right camera 2R has a viewing angle VR illustrated in the example of FIG. 14. The viewing angle VL of the left camera 2L and the viewing angle VR of the right camera 2R are wide in a direction perpendicular to the direction in which the vehicle 1 travels.

The left camera 2L may image a rear-side vehicle located far from the target vehicle and traveling on a lane located on the left side of a lane on which the target vehicle travels. The right camera 2R may image a rear-side vehicle located far from the target vehicle and traveling on a lane located on the right side of the lane on which the target vehicle travels.

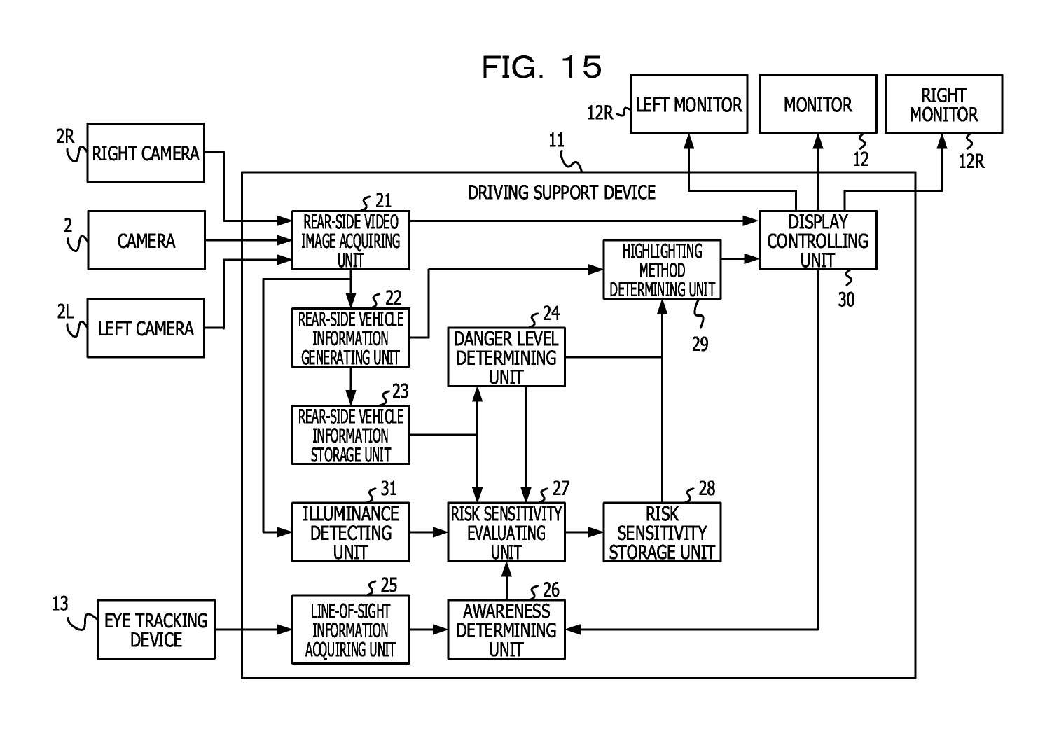

FIG. 15 illustrates an example of the driving support device 11 when the three cameras are installed. The rear-side video image acquiring unit 21 acquires video images from the camera 2, the left camera 2L, and the right camera 2R. The danger level determining unit 24 determines the danger level when at least one of the camera 2, the left camera 2L, and the right camera 2R images a rear-side vehicle.

Then, the risk sensitivity evaluating unit 27 evaluates the risk sensitivity of the driver. The highlighting method determining unit 29 determines the form of highlighting the image part 36 based on the danger level and the risk sensitivity, as described above.

Although the video images acquired by the three cameras may be displayed on the single monitor, it is preferable that the video images acquired by the three cameras be displayed on different monitors. As illustrated in the example illustrated in FIG. 15, the display controlling unit 30 displays the video images on a left monitor 12L, a right monitor 12R, and a back mirror monitor 41.

The left monitor 12L is installed on the left side of the instrument panel located at the driver's seat, for example. The right monitor 12R is installed on the right side of the instrument panel located at the driver's seat, for example. The back mirror monitor 41 displays the video image on a part of a back mirror installed above the driver's seat or displays the video images on the overall back mirror installed above the driver's seat.

If the highlighted image part 36 is superimposed on the video image acquired by the left camera 2L and depicting a rear-side vehicle, the video image that has the highlighted image part 36 superimposed thereon is displayed on the left monitor 12L. If the highlighted image part 36 is superimposed on the video image acquired by the right camera 2R and depicting a rear-side vehicle, the video image that has the highlighted image part 36 superimposed thereon is displayed on the right monitor 12R.

If the highlighted image part 36 is superimposed on the video image acquired by the camera 2, the video image that has the highlighted image part 36 superimposed thereon is displayed on the back mirror monitor 41. Thus, the image part 36 highlighted in the form determined by the highlighting method determining unit 29 is superimposed on at least one of the video images acquired by the three cameras, and the video image having the image part 36 superimposed thereon is displayed on a corresponding monitor.

The video image acquired by the left camera 2L is displayed on the left monitor 12L. The video image acquired by the right camera 2R is displayed on the right monitor 12R. The video image acquired by the camera 2 is displayed on the back mirror monitor 41.

The driver visually confirms the back mirror in order to confirm a region located on the rear side of the vehicle 1. Thus, the driver may easily become aware of the highlighted image part 36 superimposed on the video image acquired by the camera 2 and displayed on the back mirror monitor 41.

Similarly, if the highlighted image part 36 is superimposed on the video image displayed on the right monitor 12R located on the right side of the driver and is superimposed on the video image displayed on the left monitor 12L located on the left side of the driver, the highlighted image part 36 is displayed on the monitors located on the left and right sides of the driver. Thus, the driver may easily become aware of the highlighted image part 36.

### Example of Use of Two Cameras

Only two of the three cameras used in the aforementioned example may be used. For example, the cameras 2L and 2R and the monitors 12L and 12R may be used without the use of the camera 2 and the back mirror monitor 41.

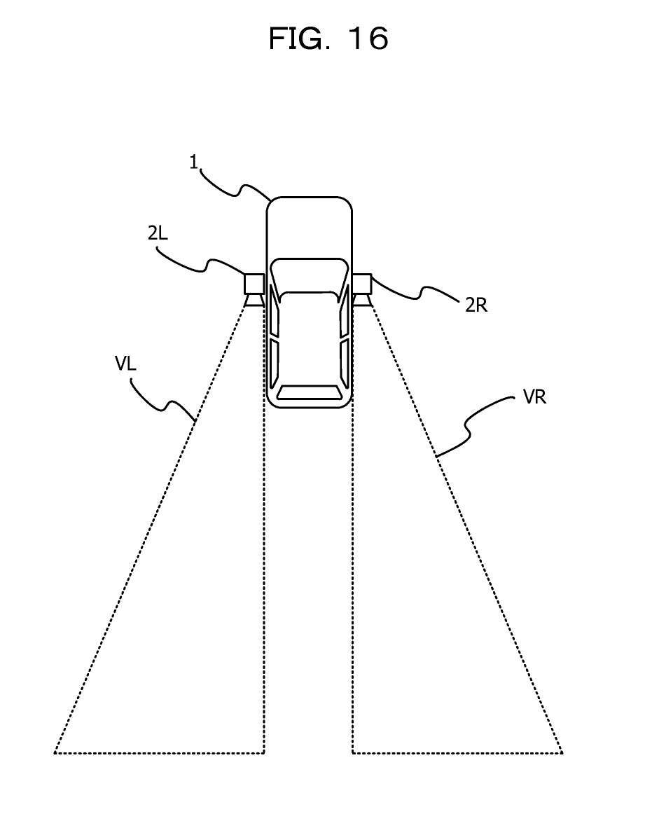

FIG. 16 illustrates an example in which the two cameras are used. FIG. 16 illustrates the example in which the left camera 2L and the right camera 2R that are among the cameras 2, 2L, and 2R illustrated in the installation example of FIG. 14 are installed on the vehicle 1.

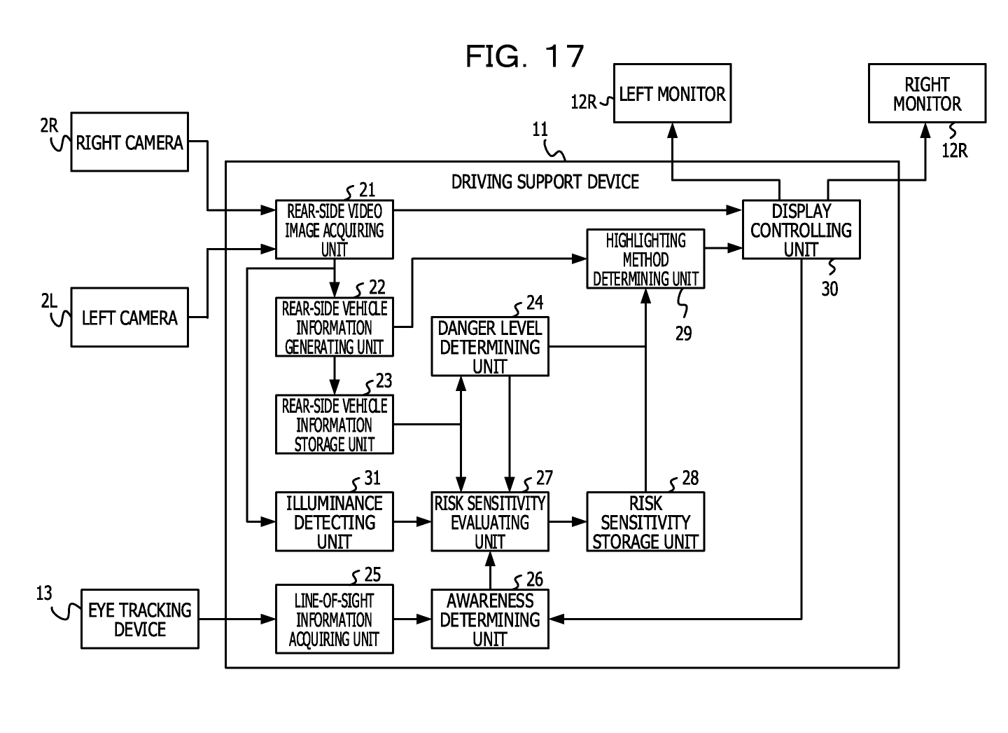

FIG. 17 illustrates an example of the driving support device 11 when the two cameras are installed. The rear-side video image acquiring unit 21 acquires video images from the left camera 2L and the right camera 2R. The danger level determining unit 24 determines the danger level when the left camera 2L or the right camera 2R images a rear-side vehicle.

Then, the risk sensitivity evaluating unit 27 evaluates the risk sensitivity of the driver. The highlighting method determining unit 29 determines the form of highlighting the image part 36 based on the danger level and the risk sensitivity, as described above.

As described above, although the video images acquired by the two cameras may be displayed on a single monitor, it is preferable that the video images acquired by the two cameras be displayed on the different monitors. As illustrated in the example of FIG. 15, the display controlling unit 30 displays the video images on the left monitor 12L and the right monitor 12R.

As described above, the left monitor 12L is installed on the left side of the instrument panel located at the driver's seat, for example. The right monitor 12R is installed on the right side of the instrument panel located at the driver's seat, for example.

If the highlighted image part 36 is superimposed on the video image acquired by the left camera 2L and depicting a rear-side vehicle, the video image that has the highlighted image part 36 superimposed thereon is displayed on the left monitor 12L. If the highlighted image part 36 is superimposed on the video image acquired by the right camera 2R and depicting a rear-side vehicle, the video image that has the highlighted image part 36 superimposed thereon is displayed on the right monitor 12R.

Thus, the image part 36 highlighted in the form determined by the highlighting method determining unit 29 is superimposed on at least one of the video images acquired by the two cameras, and the video image that has the highlighted image part 36 superimposed thereon is displayed on a corresponding monitor. The video image acquired by the left camera 2L is displayed on the left monitor 12L. The video image acquired by the right camera 2R is displayed on the right monitor 12R. Since the highlighted image part 36 is displayed on the monitors installed on the left and right sides of the driver, the driver easily becomes aware of the highlighted image part 36.

### Example of Hardware Configuration of Driving Support Device

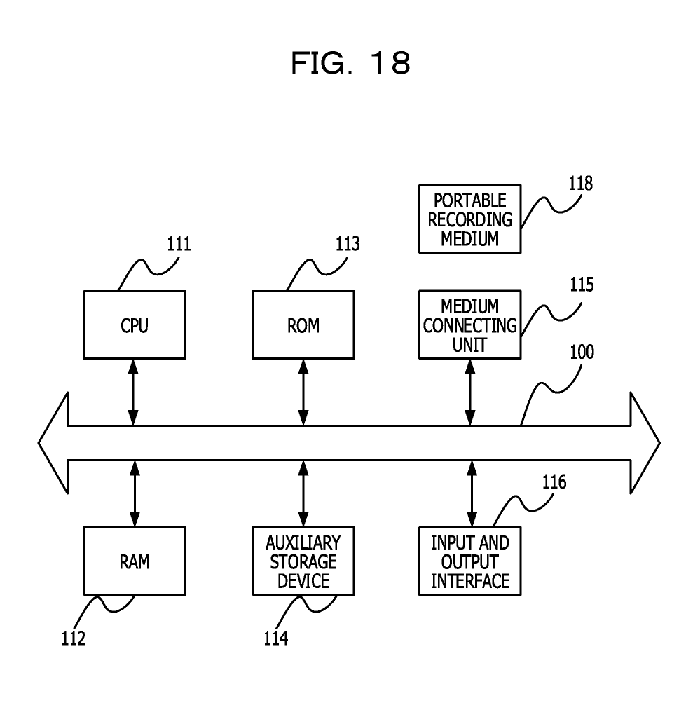

Next, an example of a hardware configuration of the driving support device 11 is described with reference to FIG. 18. As illustrated in the example of FIG. 18, a central processing unit (CPU) 111, a RAM 112, a ROM 113, an auxiliary storage device 114, a medium connecting unit 115, and an input and output interface 116 are connected to each other through a bus 100. The CPU 111 is an example of a processor as hardware.

The CPU 111 is an arbitrary processing circuit. The CPU 111 executes a program loaded in the RAM 112. As the program to be executed, a program that causes the CPU 111 to execute the processes described in the embodiment may be applied. The ROM 113 is a nonvolatile storage device that stores the program to be loaded in the RAM 112.

The auxiliary storage device 114 stores various types of information. For example, a hard disk drive, a semiconductor memory, or the like may be applied to the auxiliary storage device 114. The medium connecting unit 115 is able to be connected to a portable recording medium 118. The input and output interface 116 receives and outputs data from and to external devices. The external devices are the cameras 2, the monitors 12, the eye tracking detecting device 13, and the like, for example.

As the portable recording medium 118, a portable memory or an optical disc (for example, a compact disc (CD), a digital versatile disk (DVD), or the like) may be applied. The program that causes the CPU 111 to execute the processes described in the embodiment may be stored in the portable recording medium 118.

The rear-side vehicle information storage 23 and the risk sensitivity storage unit 28 that are included in the driving support device 11 may be achieved by the RAM 112 and the auxiliary storage device 114. The units that are included in the driving support device 11 and are not the rear-side vehicle information storage unit 23 and the risk sensitivity storage unit 28 may be achieved by the CPU 111.

The RAM 112, the ROM 113, and the auxiliary storage device 114 are examples of tangible computer-readable storage media. The tangible storage media are not temporal media such as signal carrier waves.

### Others

Evaluating the easiness of the awareness of the driver based on the awareness determined using the trajectory of the line of sight of the driver and the level of danger to the target vehicle from a rear-side vehicle, and determining the form of highlighting the image part based on the easiness of the awareness and the danger level, may promote the driver to appropriately become aware of the danger from the rear-side vehicle.

The risk sensitivity (or the easiness of the awareness) that is the sensitivity to danger to the driver varies depending on the driver. If the risk sensitivity of the driver is at the high level, the driving support device may promote the driver to become aware of danger from a rear-side vehicle by weakly highlighting the image part without strongly highlighting the image part. If the image part is strongly highlighted, the visibility may be reduced.

If the risk sensitivity of the driver is at the low level, the driving support device may promote the driver to become aware of the danger from the rear-side vehicle by strongly highlighting the image part. Thus, the driving support device evaluates the risk sensitivity of the driver, determines the form of highlighting the image part based on the risk sensitivity and the danger level, and thereby may promote the driver to appropriately become aware of the danger.

A driver who has a high driving skill tends to have high risk sensitivity. If the driver has the high driving skill and drives a vehicle for a long time, the risk sensitivity of the driver may be reduced. The risk sensitivity evaluating unit 27 evaluates the risk sensitivity of the driver every time a rear-side vehicle overtakes the target vehicle. Thus, the driving support device may promote the driver to appropriately become aware of danger based on a condition of the driver who is driving the target vehicle.

The techniques disclosed in the embodiment are not limited to the aforementioned embodiment and may include various configurations or various embodiments without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A driving support device for supporting driving of a vehicle by a driver, comprising:
a memory; and
a processor coupled to the memory and configured to:
determine a danger level indicating a level of danger regarding a target object, based on at least one of a relative velocity of the target object with respect to the vehicle and a relative distance between the vehicle and the target object,
determine, based on information of a trajectory of a line of sight of the driver, an evaluation value indicating a first probability at which the driver becomes aware of the target object, and
determine, based on the danger level and the evaluation value, a form of notifying the driver of the target object.

2. The driving support device according to claim 1, wherein the target object is another vehicle.

3. The driving support device according to claim 2, wherein the another vehicle travels on a rear side of the vehicle.

4. The driving support device according to claim 3, further comprising:
a first camera configured to acquire a first video image of a region located on the rear side of the vehicle; and
a display configured to display the first video image.

5. The driving support device according to claim 4, wherein the display highlights the another vehicle on the first video image according to the form.

6. The driving support device according to claim 5, wherein, as the danger level is higher and the evaluation value is lower, the display highlights the another vehicle on the first video image more strongly.

7. The driving support device according to claim 5, further comprising
a second camera configured to acquire a second video image capturing eyes of the driver,
wherein the information of the trajectory is generated based on the second video image.

8. The driving support device according to claim 7, wherein the evaluation value is related to a frequency at which the driver places the line of sight on the display.

9. The driving support device according to claim 7, wherein the processor is configured to update the evaluation value to another evaluation value indicating a second probability at which the driver becomes aware of the another vehicle and is higher than the first probability when the driver is determined to have looked at the display within a certain time period after the display highlighted the another vehicle.

10. The driving support device according to claim 5, wherein the processor is configured to:
determine, as the danger level, a first level from among a plurality of first levels based on at least one of the relative velocity and the relative distance,
determine, as the evaluation value, a second level from among a plurality of second levels based on the trajectory of the line of sight, and
control the form of notifying the driver based on the first level and the second level.

11. The driving support device according to claim 10, wherein the processor is configured to maintain a level of highlighting the another vehicle based on the first level and the second level.

12. The driving support device according to claim 10, wherein the processor is configured to change the level of highlighting the another vehicle in a stepwise manner based on the first level and the second level.

13. The driving support device according to claim 3, wherein
the danger level is a higher one of a first danger level band a second danger level,
the first danger level is based on a collision margin time obtained by dividing the relative distance by the relative velocity, and
the second danger level is based on the relative distance.

14. The driving support device according to claim 4, wherein the processor is configured to:
detect the another vehicle from the first video image, and
calculate the evaluation value when a time period from the time when the another vehicle is detected to the time when the another vehicle overtakes the vehicle is longer than a threshold.

15. The driving support device according to claim 3, further comprising
a sensor configured to detect illuminance of a region surrounding the vehicle,
wherein the evaluation value is determined based on the illuminance.

16. A driving support method, executed by a computer, for supporting driving of a vehicle by a driver, the driving support method comprising:
determining a danger level indicating a level of danger regarding a target object, based on at least one of a relative velocity of the target object with respect to the vehicle and a relative distance between the vehicle and the target object;
determining, based on information of a trajectory of a line of sight of the driver, an evaluation value indicating a first probability at which the driver becomes aware of the target object; and
determining, based on the danger level and the evaluation value, a form of notifying the driver of the target object.

17. A non-transitory storage medium storing a driving support program for supporting driving of a vehicle by a driver, which causes a computer to execute a procedure, the procedure comprising:
determining a danger level indicating a level of danger regarding a target object, based on at least one of a relative velocity of the target object with respect to the vehicle and a relative distance between the vehicle and the target object;
determining, based on information of a trajectory of a line of sight of the driver, an evaluation value indicating a first probability at which the driver becomes aware of the target object; and
determining, based on the danger level and the evaluation value, a form of notifying the driver of the target object.
